(19) United States
(12) Patent Application Publication
(10) Pub. No.: US 2015/0286721 A1
(43) Pub. Date: Oct. 8, 2015

(54) System and Method for Returning Precise Internet Search Results

(71) Applicant: Eugene Voronov, L.A., CA (US)

(72) Inventor: Eugene Voronov, L.A., CA (US)

(21) Appl. No.: 14/245,958

(22) Filed: Apr. 4, 2014

(51) Int. Cl. G06F 17/30

(52) U.S. Cl. CPC G06F 17/30864; G06F 17/3053; G06F 17/30598; G06F 17/30011

(57) ABSTRACT

In accordance with one embodiment, a system and method of returning precise search results that allows its users to the option to compare different results, to ask questions and get answers instead of hyperlinks, and that can guide the user to making precise search queries. The present invention accomplishes these objectives leading to search results that comprise fewer marginal websites while reducing user frustration and making web search more satisfying and effective.

### CROSS-REFERENCE TO RELATED APPLICATIONS

None

### BACKGROUND

The following is a tabulation of some prior art that presently appears relevant:

U.S. Pat. Nos.

| Pat. No. | Kind Code | Issue Date | Patentee |
|---|---|---|---|
| 6,000,063 | A | Dec. 14, 1999 | Sullivan |
| 6,108,817 | A | Aug. 29, 2000 | Kostelac |
| 6,691,155 | B2 | Feb. 10, 2004 | Gottfried |
| 7,0552,273 | B2 | Jun. 6, 2006 | Roshkoff |
| 8,141,281 | B2 | Mar. 27, 2012 | Sample |
| 8,296,229 | B1 | Oct. 23, 2012 | Yellin et al. |
| 8,321,792 | B1 | Nov. 27, 2012 | Alur et. al. |
| 8,396,742 | B1 | Mar. 12, 2013 | Blume et al. |
| 8,407,607 | B2 | Mar. 26, 2013 | Bragun et. al. |

U.S. Patent Application Publications

| Publication Number | Kind Code | Publ. Date | Applicant |
|---|---|---|---|
| 2007/0277286 | A1 | Dec. 6, 2007 | Gleeson |
| 2013/0070163 | A1 | Mar. 21, 2013 | Connors |
| 2013/0124301 | A1 | May 16, 2013 | Bachman |

Foreign Patent Document
None found
Nonpatent Literature Documents
None found

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### DISCUSSION OF THE RELATED ART

Today, there are over one hundred million websites available on the most visible part of the Internet, the World Wide Web, waiting to provide end users with information on a seemingly endless number of topics. The draw back of having so many sites available for viewing is parsing through all the information to find what the end user is looking for accurately and therefore efficiently.

To help with the problem, most users turn to Internet search engines. These are special sites on the Internet designed to help users find information stored on other sites. The basic way search engines go about this task comprises the steps of: searching the Internet, usually with the aid of a software program called a crawler; indexing the information returned by the search program; and allowing an end user to look for words or combinations of words stored in that index.

Search engines may base their determination of the user's interest on search terms (called a search query) entered by the user. The goal of the search engine is to identify links to high quality relevant results based on the search query. Typically, the search engine accomplishes this by matching the e the search query to a corpus of pre-stored web documents. Web documents that contain the user's search terms are considered “hits” and are returned to the user. The corpus of pre-stored web documents may be stored by the search engine as an index of terms found in the web pages.

Documents in the index may be categorized into one or more categories. Examples of such categories include general web documents, commercial products, images, sponsored advertisements/links, and news documents. Dividing the index into categories can be beneficial in helping users find more relevant results to their search queries. For example, a user interested in find g a digital camera to purchase may be particularly interested in specific models and prices of digital cameras and not as interested in information relating to the taking of digital pictures. One problem associated with search engines capable of performing multi-category searches is how to present the different category options to users. One known technique is to allow the user to pick the desired category and to then enter a search query. The user ma.), for example, first select a “news” tab from the search engine's home page and then enter a search query that will be applied to an index of news documents. Although this technique gives users a great deal of control in directing search queries, a practical problem with this technique is that a large majority of users tend to ignore the category tabs, resulting in their search query being directed to the default category. Thus, there is a need in the art to assist users in more effectively searching information segmented by category.

The goal of the search engine must be to store information in a way that makes it useful for the end user to find what they are looking for. To date, two forms of searches are common. Literal searches and natural language searches. In a literal search, one which is most often defined b Boolean operators, the search engine looks for words or phrases exactly as they are entered by the end user.

Because it is so literal, this type of search can lead the user to Web sites that have no interested in visiting. This problem may occur when the entered terms have multiple meanings. For example, “blind” may have one meaning when following the word “window” as in “window blind” and a completely different meaning when preceding the word “man.” If the user is interested in only one of these meanings, they will not want to be bombarded with many pages featuring all of the others.

Another common search engine uses a different search referred to as a natural-language query. These queries allow the user to enter a question in the same way they would ask it to another person. Thus, eliminating the need to keep track of Boolean operators or complex query structures.

The most most popular search engine today, Google®, do nor guide the user to submit the most precise search query. Instead, they require him/her to enter in a number of queries if they don't get what they are looking for on the first try. Results on Googles® search engine are displayed as a list in rank order store on their database and indexed to the information collected by their crawler programs.

Finally, during recent years, Google's® search algorithm has become susceptible to a phenomenon commonly referred to as index-spamming. This is when the owner of a web site may artificially increase their ranking with thousands of words on pages concealed by matching the background color. This phenomena has made the results less reliable thereby reducing the chance a user will be satisfied with the results of their search query.

Even though a number of Internet search engines have been proposed in the past, all of the those heretofore known suffer from a number of disadvantages:
(a) the known Internet search engines only offer the user way to input their query;
(b) the known Internet search engines do not have an integral comparison search;
(c) the known Internet search engines do not assist the user in entering more specific queries;
(d) the known Internet search engines do not provide hyperlinks for all terms on the results page;
(e) the known Internet search engines do not ask you whether you would like to utilize an information, comparison, or observation search engine;
(f) the known Internet search engines do not allow you to edit text directly on the search results page;
(g) the known Internet search engines do not preferably format the results of the search depending on what type of search the user had requested;
(h) the known Internet search engines force you to copy and paste results into a word processor before the text contained therein can be modified; and
(i) the known Internet search engines do not use non-boolean operators to the guide the search engine to ask more specific questions and make precise queries.

Various systems and methods for searching content on the Internet have been proposed. However, none of the foregoing combine the characteristics of the present invention. Therefore, there is a need for a system and method of returning precise search results that allows its users to the option to compare different results, to ask questions and get answers instead of hyperlinks, and that can guide the user to making precise search queries. The present invention effectuates these needs with search results that comprise fewer marginal websites thus reducing user frustration and making web search more satisfying and effective.

### SUMMARY

In one embodiment, a system and method of returning precise Internet search results includes selecting from one of at least three query options, receiving query information from a search requestor, prior to the user indicating completion of the query. From the received query information a set of predicted queries ordered in accordance with a ranking criteria is predicted. The set of ordered predicted queries is then transmitted to the search requestor and presented depending on the type of query that they has originally selected.

In one embodiment of the present invention, the user is present with three different query options. The three options may include: Information, Compare, and Observe. The user or search requestor may select a respective query from the ordered set of predicted queries and then indicate completion of the query or they may modify the original query or type of query option they originally selected. A search engine processes the query to produce a set of search results. Alternately, the search requestor may continue entering query information until a complete query is entered, or until a new set of predicted queries is transmitted and presented to the search requestor.

If the Information query is selected, the user may ask question such as “what is the biggest lake in the world?” the system and method will then perform a search and answer the users questions. The user will also be presented with a series of additional links which they may follow to learn more about the answer to the question. The user will also be presented with a series of information about the sources used by the search engine to return its answer.

If the Compare option is selected, first the user selects the number of items they would like to compare. The user is then present with a number of input boxes to match the number of items they requested to be compared. The user is then prompted to fill in each box and the results are presented. The manner presenting the search results differs from the other query methods in that information about the compared items is categorized by the search engine and presented side by side in a column format. In one example, the user would select Compare; then the number two, and he would input the names of 2 different cars (one in each box). The search engine would then return two columns with information such as horsepower, miles per gallon (mpg), cargo room, etc. side-by-side for the two cars so that the user could make a comparison.

In one embodiment of a system and method of returning precise Internet search results, the results may appear as a series of modifiable text. The text may be edited by the user just as they would using a word processor. The user may then copy and past their findings into a separate document file on their computer.

### ADVANTAGES

Thus several advantages of one or more aspects are to provide a system and method of returning precise Internet search results that:
(a) offers multiple ways to input a search query depending on the type of search the user would like to conduct;
(b) provide an Internet search engine that has a comparison search option;
(c) provide an Internet search engine that assists the user to enter more specific search queries;
(d) provide an Internet search engine that provides hyperlinks for all terms on the results page;
(e) provide an Internet search engine that offers its users an information, observation, or comparison search option;
(f) provide an Internet search engine allows users to edit text directly on the search results screen;
(g) provide an Internet search engine that preferably formats the results of the search depending on the type of search that the user has requested; and
(h) provide an Internet search engine that uses non-boolean operators to guide the search engines to ask question that aid the user to make more specific queries.

These and other advantages of one or more aspects will become apparent from consideration of the ensuing description and accompanying drawings. Although the description above contains many specificities, these should not be construed as limiting the scope of the embodiments but as merely providing illustrations of some of several embodiments. Thus the scope of the embodiments should be determined by the claims that are appended and their legal equivalents, rather than by the examples given.

The description of the invention which follows, together with the accompanying drawings should not be construed as limiting the invention to the example shown and described, because those skilled in the art to which this invention pertains will be able to devise other forms thereof within the ambit of the appended claims.

Although the description that follows contains many specificities, these should not be construed as limiting the scope of the embodiments but as merely providing illustrations of some of several embodiments. Thus the scope of the embodiments should be determined by the claims that are appended and their legal equivalents, rather than by the examples given. Those skilled in the art to which this invention pertains will be able to devise other forms thereof within the ambit of the appended claims.

### DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

Figures

FIG. 1 is a block diagram that illustrates a client-server of a computing environment configured for a system and method of returning precise Internet search results, according to one embodiment of the invention;

FIG. 2 depicts a process for processing historical queries, according to one embodiment of the invention;

FIG. 3 is a block diagram illustrating the classification of documents into different categories;

FIG. 4 is a block diagram conceptually illustrating functional components of the search engine;

FIG. 5 is a diagram illustrating an exemplary web page that contains search results organized into a number of visual categories;

FIG. 6 illustrates an example search page for a system and method of returning precise Internet search results according to one embodiment of the invention; and

FIG. 7 is a block diagram of a non-limiting example system in accordance with present principles for a system and method of returning precise Internet search results from the consumers perspective.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely alive and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the ion is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-irritable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, he routines executed to implement the embodiments of the invention, may be part of an operating system or a specific application, component, program, module, object, or sequence of instructions. The computer program of the preset invention typically is comprised of a multitude of instructions that will be translated by the native computer into a machine-readable format and hence executable instructions. Also, programs arc comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It to be understood that the terms so used are interchangeable under appropriate circumstances such that the embodiments described herein are, for example, capable of operation in sequences other that those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Illustrative embodiments of the invention are described below. The showings are for purposes of illustrating preferred embodiments and not for purposes of limiting the same. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

Embodiments of the present invention provide techniques for returning more precise Internet search results then any other search engine presently known in the art. Because Internet content is changing constantly, there exists a need to sort that content and provide results in a more accurate and efficient manner than what is presently available. This information should be organized and tabulated to provided users with precise result for their search queries.

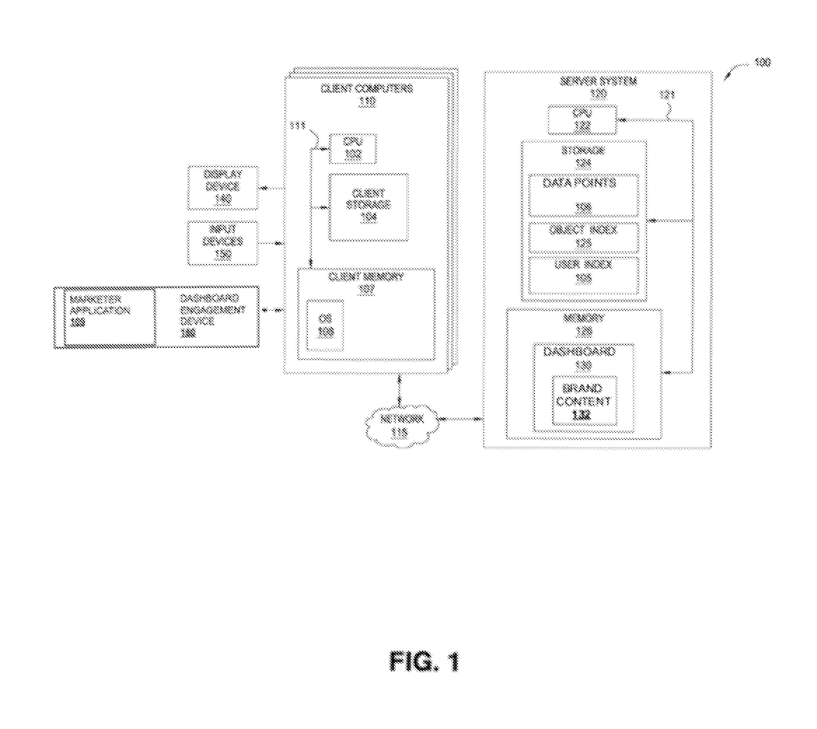

FIG. 1 is a block diagram that illustrates a client server view of a computing environment 100 configured for displaying for a system and method of returning precise Internet search results, according to one embodiment of the invention As shown, computing environment 100 includes client computers 110, network 115, and server system 120. In one embodiment, the computer systems illustrated in FIG. 1 are included to be representative of existing computer systems, e.g., desktop computers, server computers, laptop computers, tablet computers, and the like. The computing environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking on-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are limited to any currently existing computing environment or programming language, and may be adapted to take advantage of new computing systems as they become available.

As shown, server system 120 includes a CPU 122, which obtains instructions and data via a bus 121 from memory 126 and storage 124. The processor 122 could be any processor adapted to support the methods of the invention. The memory 126 is any memory sufficiently large to hold the necessary programs and data structures.

Memory 126 could be one or a combination of memory devices, including Random Access Memory, nonvolatile or backup memory, (e.g., programmable or Flash memories, read-only memories, etc.). In addition, memory 126 and storage 124 may be considered to include memory physically located elsewhere in a server 120, for example, on another computer coupled to the server 120 via bus 121. Server 120 may be operably connected to the network 115, which generally represents any kind of data communications network. Accordingly, the network 115 may represent both local and wide area networks, including the Internet.

Like server system 120, each consumer's computer 110 includes a CPU 102, bus 111, consumer's memory 107, and consumer's storage 104. CPU 102 is a programmable logic device that performs all the instruction, logic, and mathematical processing in a computer consumer's storage 104 stores application programs and data for use by consumer's computer 110. Consumer's storage 104 includes hard-disk drives, flash memory devices, optical media and the like. Consumer's computer 110 is operably connected to the network 115.

Consumer's memory 107 stores elements of an operating system (OS) 108 and a marketer's application 109. Operating system 108 is the software used for managing the operation of the client computer 110. Examples of an operating system 108 include UNIX, a version of the Microsoft Windows® operating system, and distributions of the Linux® operating system.

The user may view the system and method of returning precise Internet search results 130 using a display device 140, such as an LCD or CRT monitor display, and interact with the market's application 109 using input devices 150 (e.g., a keyboard and a mouse). Further, in one embodiment, the user may interact with the search engine 109 and marketer's dashboard 130 using a variety of dashboard engagement devices 160. For example, the consumer may use a device such as a universal serial bus (USB) key. Of course, embodiments of the invention are not limited to these examples and one of ordinary skill in the art will readily recognize that the invention may be adapted for use with a variety of devices configured to present actions of the user into actions performed by that user within marketer's dashboard 130.

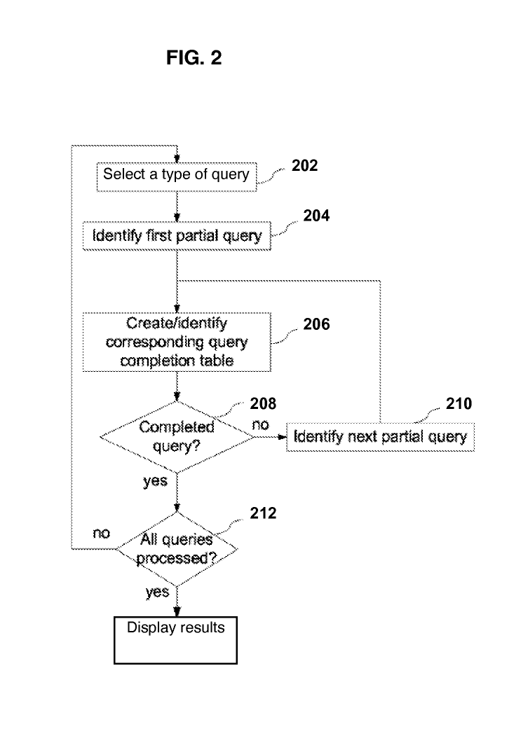

FIG. 2 depicts a process for processing queries. In some embodiments, only queries having the desired meta-information are processed (e.g., queries in the English language). The first partial query is identified from the selected query (204). In one embodiment, the first partial query is the first character of the selected query (i.e., “h” for a query string of “hot dog ingredients”). In some embodiments, preprocessing is applied before partial queries are identified (e.g., stripping off “http://” or “www.”). An entry is made in a table which indicates the partial query, the complete query corresponding to the partial query and its frequency. In other embodiments, other information which is used for ranking is stored (e.g., date/time values, or a ranking score computed based on two or more factors). If the partial query does not represent the entire query, then the query processing is not complete (208—no). Accordingly, the next part query is identified (210). In some embodiments, the next partial query is identified by adding the next additional character to the partial query previously identified (i.e., “ho” for a query string of “hot dog ingredients”). The process of identifying (210) and of updating of a query completion table (206) continues until the entire query is processed (208—yes). If all of the queries have not yet been processed (212—no), then the next query is selected and processed until all queries are processed (212—yes). In some embodiments, as items are added to a query completion table, the items are inserted so that the items in the table are ordered in accordance with the rank or score. In another embodiment, all the query completion tables are sorted at the end of the table building process so that the items in each query completion table are ordered in accordance with the rank or score of the items in the query completion table. In addition, one or more query completion tables may be truncated so that the table contains no more than a predefined number of entries.

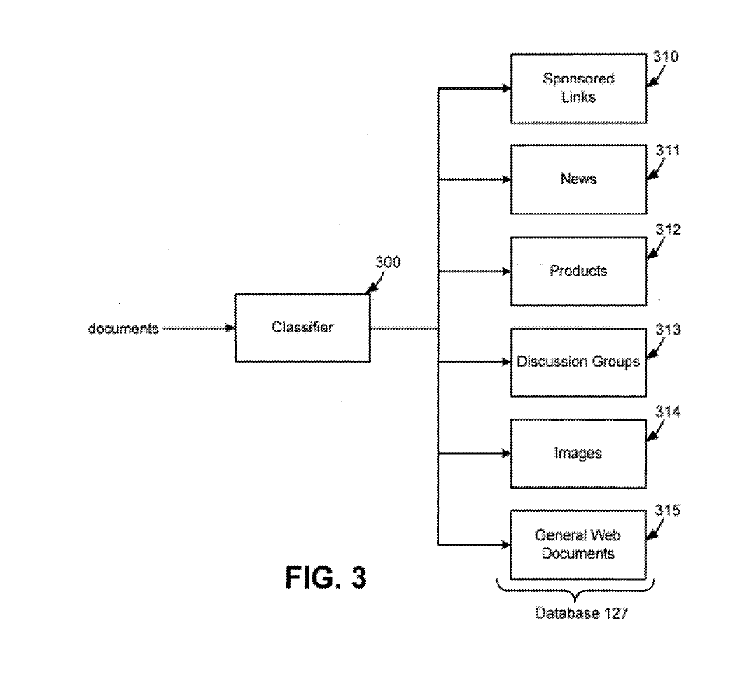

A search engine may operate on an index of documents stored in database. The documents in database may include different categories of documents. In some implementations, each different category of documents may be stored as a separate document index. FIG. 3 is a block diagram illustrating classification of documents into different categories. Incoming documents, such as documents crawled from the web or otherwise input to search engine, may be input to a classifier 300. Classifier 300 may classify the documents based on their content. Possible classifications include sponsored links, news documents, product documents, documents summarizing discussion groups, images, and general web documents. Other classifications are, of course, possible. A product document may be a web page for a product that is for sale. A discussion group document may be an archive of an on-line discussion group or web pages that include the discussion group. A news document may include documents relating to news items or current events. Sponsored links may include links that a third-party pays the search engine operator to display (e.g., advertisements). In some implementations, a document may be classified as belonging to multiple classifications.

Classifier 300 may be an automated classifier that bases its decisions on, for example, the source of the documents, document content, and/or document structure. Techniques for classifying documents are well known in the art and will not be described further herein. The classified documents may be stored as separate categories or “genres” within the complete document database, illustrated as sponsored links category 310, news category 311, products category 312, discussion groups category 313, images category 314, and general web documents category 315. One of ordinary skill in the art will recognize that more, fewer or different categories could be used. Each category 310-315 may be separately indexed by search engine.

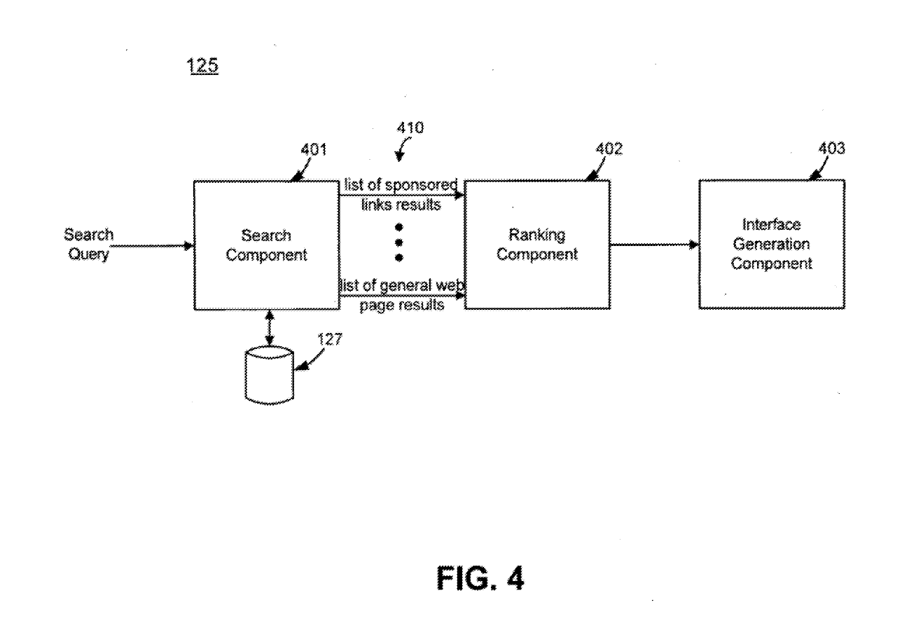

FIG. 4 is a block diagram conceptually illustrating functional components of search engine. Search engine 125 may include a search component 401, a ranking component 402, and an interface generation component 403. In general, search component 401 may receive user search queries, access database 127 based on the search queries, and obtain lists of links 410 (e.g., URLs) of relevant documents. The lists of links may also include information that generally attempts to describe the content of the web documents associated with the links. Each list in the lists of links may be associated with one of document categories 310-315. Thus, the first list may be of sponsored links that are relevant to the user search query, the second list may be of news articles relevant to the user search query, etc.

The lists may be generated, for example, by search component 401 by individually applying the user search query to each document category 310-315. Within each list of relevant links, the list may be ordered by perceived relevance to the user search query. In general, processes for searching an indexed corpus of documents to return relevant documents are well known in the art. Accordingly, the functionality of search component 401 related to performing a search based on a user query and ranking the results within a list according to perceived relevance will not be described further herein.

The lists of links 410 may be ranked by ranking component 402. Ranking component 402 may analyze the links in lists 410 and/or the documents corresponding to the links and, based on the analysis, determine a relative relevance of the lists. In other words, based on the search results generated from each category 310-315, ranking component 402 may rank the categories by perceived relevance to the user search query. Ranking component 402 may base its ranking on the documents corresponding to the links in each list and/or the user search query. For example, ranking component 402 may generally compare the search query to the contents of the documents in each list and base its ranking values on the closeness of the comparison. Consider the search query “buy athletic shoes.” For this search query, ranking component 402 may determine that the user is most likely interested in athletic shoes that are for sale. Accordingly, ranking component may rank the “products” category highly.

The links in the list of links that correspond to the products category are likely to be links that correspond to web pages that are offering shoes for sale. As another implementation of ranking component 402, the ranking component may look for terms in the search query that tend to indicate a particular category is likely to be related. For example, the word “buy” in a search query may indicate the “products” category should be ranked highly. Interface generation component 403 may generate a document, such as a web page, that contains the results of the search query. The results may be organized on the web page in a manner that generally corresponds to the rankings generated by ranking component 402.

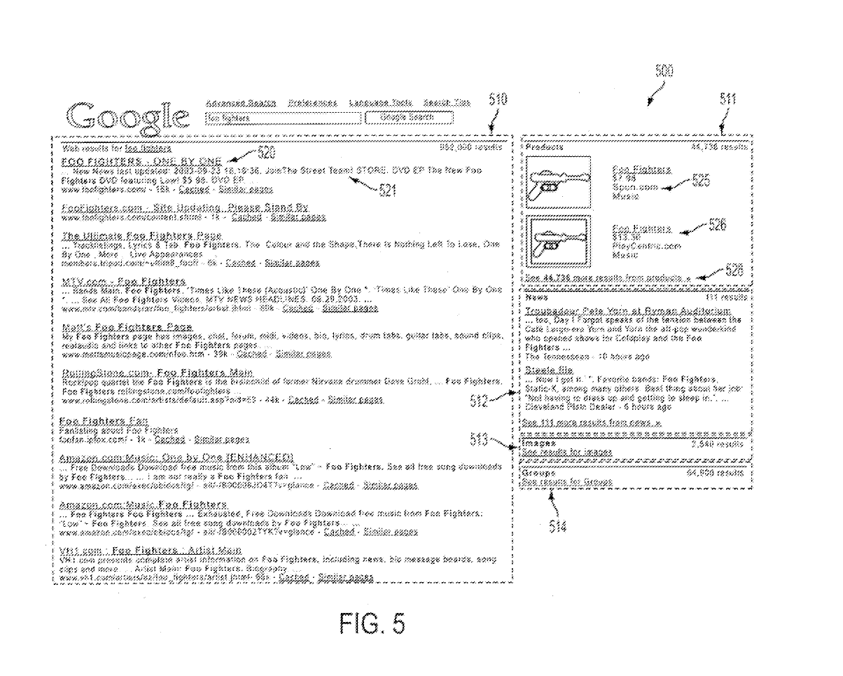

Categories that are determined to be more relevant than others by ranking component 402 may be presented more prominently on the web page. FIG. 5 is a diagram illustrating an exemplary web page 500 that contains search results organized into a number of categories. The results on web page 500 were returned by search component 401 for the exemplary search “foo fighters.” The various sections in web page 500 are demarcated by dashed lines. As illustrated, the largest section, section 510, contains general web page results for the search query “foo fighters.” Thus, general web page category 315 may have been selected as the highest ranked category by ranking component 402.

In some implementations, because search engine users may expect to receive links derived from a general index of the web, interface generation component 403 may always construct web page 500 with the general web page category 315 as the most prominent category. Section 510 may contain a number of links (e.g., hyper-text transfer protocol links) to relevant documents, such as link 520. Link 520 may additionally include a textual snippet 521 that provides additional information about the document referred to by link 520. Snippet 521 may be derived from the contents of the document. Products section 511 and news section 512 are also relatively prominently displayed in web page 500. The links in products section 511 and news section 512 may therefore have been determined to be relevant to the user's search query, although potentially not as relevant as the links in general web results section 510. Accordingly, sections 511 and 512 may include fewer links than section 510. In particular, as shown, section 511 includes two links, links 525 and 526. Section 512 may also include two links. The links in products section 511 may be derived from products category 312 and may include information relevant to a user wishing to purchase a product, such as images of the products, prices, and the names of the merchants selling the products. In this case, the search term “foo fighters” is a musical group and the most relevant product links are two links selling one of the group's music albums.

Products section 511 also includes a link 528 that indicates that additional product links are available. As shown, link 528 indicates how many other hits were generated in the products category. By selecting link 528, the user may be presented with another web page showing additional links from product category 312. As shown, news section 512 may be structured similarly to products section 511. News section 512 contains a number of links to news articles from news documents category 311.

News section 512 may also include a link indicating additional news items are available. Other categories, such as image section 513 and groups section 514 may also be displayed in web page 500. These categories may correspond to categories that ranking component 402 determines to be less relevant than the categories corresponding to sections 510, 511, and 512. As shown, no links may be explicitly shown in image section 513 and groups section 514. Instead, sections 513 and 514 may only indicate the number of hits in that category and a link to the results in that category. In this manner, the user is made aware that these categories are available and contain possibly relevant results, but web page 500 is not cluttered with an excessive amount of information. It can be appreciated that the specific organization of sections 510-514 is exemplary.

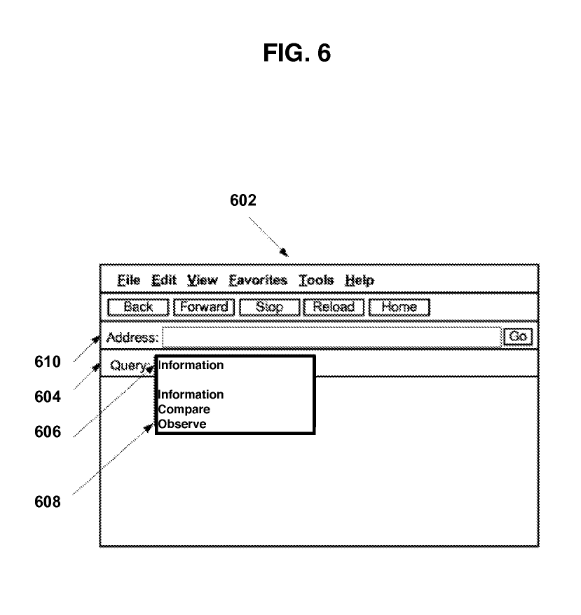

More particularly, the number, size, and layout of the sections could be changed. FIG. 6 is a flow chart illustrating operations that may be performed by search engine 125 consistent with aspects of the invention. Search engine 125 may receive a search query from a user. Search component 401 may search multiple categories of documents, such as document categories 310-315, based on the search query. The search may result in, for at least two categories, a list of relevant documents or links to the relevant documents.

Ranking component 402 may then rank the various categories based on the results returned from search component 401. Interface component 403 may then generate the resultant web page that is to be returned to the user. As illustrated in FIG. 5, above, the web page may include links from multiple categories, organized, at least in part, based on category relevance. Server 120 may return the generated web page to the user.

FIG. 6 illustrates a user's view when using a browser and toolbar according to some embodiments of the invention. A browser 602 includes a toolbar 604 including a text entry box 1106 depicting the entry of a partial query <hot>. In response to detecting the partial query and ultimately receiving the predicted queries from the query server, the predictions are displayed in display area 608 for possible selection by the user. Similarly, while not shown, in response to detecting user entry of a partial URL in an address bar 610, an ordered set of predicted URLs may be displayed in a display area (not shown) immediately below or adjacent the address bar 610 for possible selection by the user.

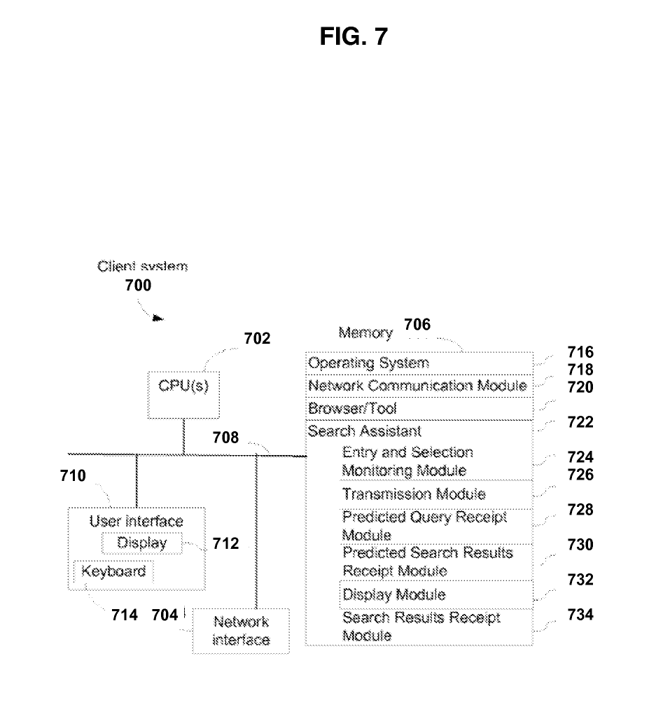

Referring to FIG. 7, an embodiment of a client system 700 that implements the methods described above includes one or more processing units (CPU's) 702, one or more network or other communications interfaces 704, memory 706, and one or more communication buses 708 for interconnecting these components. The search engine 700 may optionally include a user interface 710 comprising a display device 712 and/or a keyboard 714. Memory 706 may include high speed random access memory and may also include non-volatile memory, such as one or more magnetic or optical storage disks. The memory 706 may include mass storage that is remotely located from CPU's 702. The memory 706 may store:
(a) an operating system 716 that includes procedures for handling various basic system services and for performing hardware dependent tasks;
(b) a network communication module (or instructions) 718 that is used for connecting the client system 700 to other computers via the one or more communications network interfaces 704 and one or more communications networks, such as the Internet, other wide area networks, local area networks, metropolitan area networks, and so on; and
(c) a browser or tool 720 for interfacing with a user to input search queries, and for displaying search results; and
(d) a search assistant 722.

In some embodiments, the search assistant 722 is separate from the browser/tool 720, while in other embodiments the search assistant is incorporated in the browser/tool 720.

The search assistant 722 may include the following elements, or a subset of such elements: an entry and selection monitoring module (or instructions) 724 for monitoring the entry of search queries and selecting partial queries for transmission to the search engine; a transmission module (or instructions) 726 for transmitting partial search queries and final search queries to the search engine; a predicted query receipt module (or instructions) 728 for receiving predicted queries; a predicted search results receipt module (or instructions) 730 for receiving predicted search results; display module (or instructions) 732 for displaying predictions and results; and optionally, a search results receipt module (or instructions) 734 for receiving search results. The transmission of final (i.e., completed) queries, receiving search results for completed queries, and displaying such results may be handled by the browser/tool 720, the search assistant 722, or a combination thereof. The search assistant 722 may also provide a corresponding set of functions for handling partial and complete URLs, which may be handled by either the same elements or a parallel set of elements as those described above.

### CONCLUSIONS, RAMIFICATIONS, AND SCOPE

While a particular form of the invention has been illustrated and described, it will be apparent that various modifications can be made without departing from the spirit and scope of the invention. Accordingly, is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method of returning precise Internet search results with which that terminology is associated. In general, the terms used in the following claims should not be constructed to limit the system and method of returning precise Internet search results to the specific embodiments disclosed in the specification, unless the above description section explicitly define such terms. Accordingly, the actual scope encompasses not only the disclosed embodiments, but also all equivalent ways of practicing or implementing the disclosed the system and method of returning precise Internet search results. The above description of embodiments of the system and method of returning precise Internet search results is not intended to be exhaustive or limited to the precise form disclosed above or to a particular field of usage. While specific embodiments of, and examples for, the system and method are described above for illustrative purposes, various equivalent modifications are possible which those skilled in the relevant art will recognize.

While certain aspects of the system and method of returning precise Internet search results are presented below in particular claim forms, the inventors contemplate the various aspects of the system and method in any number of claim forms. Accordingly, the inventor reserves the right to add additional claims after filing the application to pursue such additional claim forms for other aspects of the system and method of returning precise Internet search results.

What is claimed is:

1. A computer-based method of returning more precise Internet search results, comprising the steps of:
a. allowing a user to select one of at least 3 different types of query input methods via a web browser, the Internet, and a web server;
b. receiving a search query from said user;
c. using a particular search engine to obtain a set of search results based on said query;
d. said search engine to be determined by the type of query input method selected by said user;
e. using said selection to change the presentation of a search result for said query; and
f. returning search results to said user.

2. A computer-based method of returning more precise Internet search results, comprising the steps of:
a. performing a search to determine documents related to a search query, the search being performed on a database containing a plurality of document categories to obtain a list of search results corresponding to each of at least three of the categories;
b ranking the lists of search results relative to one another; and generating a result in which the search results are placed in an organization determined based, at least in part, on the ranking of the lists of search results; and displaying said results in a manner dictated by said categories.

3. The method of claim 2, wherein the organization of the generated document includes three or more of the lists of search results placed in a separate input bar.

4. The method of claim 3, wherein more highly ranked lists of search results are displayed more prominently in the generated document than less highly ranked lists of search results.

5. The method of claim 3, wherein the generated document includes the search results as hyper-text transfer protocol (HTTP) links.

6. The method of claim 2, wherein the generated document is presented as modifiable text.

7. The method of claim 3, wherein at least one of the sections includes a title describing the category corresponding to the section.

8. The method of claim 3, wherein at least one of the sections includes a link to additional search results for the category corresponding to the section.

9. The method of claim 2, wherein the generated document is a web page.

10. The method of claim 2, wherein ranking the lists of search results is performed based on documents in the lists of search results.

11. The method of claim 2, wherein ranking the lists of search results is performed based on the search query.

12. The method of claim 2 wherein the first category is titled “Information.”

13. The method of claim 2, wherein wherein the second category is titled: “Compare.

14. The method of claim 2, wherein the third category is titled “Compare.”

15. A method of organizing and presenting Internet search results categorized into a plurality of categories, the method comprising:
the user selecting a type of search method from the list comprising of Information, Compare, and Observe;
ranking the plurality of categories based on contents of the documents in each of the categories;
and generating a results document in which the documents are organized by category and in which the documents of higher ranking categories are more prominently placed in the results document.

16. The method of claim 15, further comprising:
receiving a search query; and performing a search based on the search query in each of the plurality of categories to locate the documents.
The method of claim 22, wherein the documents are placed in the results document as hyper-text transfer protocol (HTTP) links.

17. The method of claim 16, wherein links and date are presented as text which is modifiable.

18. The method of claim 15, wherein the results document includes titles describing the categories.

19. The method of claim 15, wherein the results document includes links to additional search results for the categories.

20. The method of claim 15, wherein the results document is a web page.
